(19) United States
(12) Patent Application Publication
(10) Pub. No.: US 2009/0319325 A1
(43) Pub. Date: Dec. 24, 2009

(54) TRANSFERRING A DIGITAL IMAGE FROM A PHOTOGRAPHER TO A FULFILLMENT CENTER TO GENERATE A PHOTOGRAPHIC PROCESS

(75) Inventors: Rodney T. Whisnant, Austin, TX (US); Kevin E. McFarland, Austin, TX (US); Graham R. McFarland, Austin, TX (US)

Correspondence Address: PATTON BOGGS LLP, 1801 CALFORNIA STREET, SUITE 4900, DENVER, CO, 80202, US

(73) Assignee: Express Digital Graphics, Inc., Austin, TX (US)

(21) Appl. No.: 12/487,632

(22) Filed: Jun. 18, 2009

Related U.S. Application Data
(63) Continuation-in-part of application No. 09/960,162, filed on Sep. 20, 2001, now abandoned.

(51) Int. Cl. G06Q 10/00

(52) U.S. Cl. 705/8

(57) ABSTRACT

A photographer computing device is described. The device receives information that specifies option(s) to create a photographic product from a digital image; a list of fulfillment center(s) to generate the product according to the options, and routing information to at least one of the center(s). The device transmits an order for the product to at least one center. The order specifies a method (e.g., at will or within a specified or negotiated period of time) for the device to communicate the image to selected ones of the center(s). The delivery method is independent of receipt of any type of request or prompt for the image from any other computing device including the gateway device and any fulfillment center. The device uploads the image as per the delivery technique and receives confirmation that the order has been received.

### RELATED APPLICATIONS

This patent application is a continuation-in-part of, and claims priority to, U.S. patent application Ser. No. 09/960,162 filed on Sep. 20, 2001, titled “System For Transferring A Digital Image From A Photographer To A Fulfillment Center To Generate A Photographic Process”, which is hereby incorporated by reference.

### BACKGROUND

Digital cameras have proliferated greatly as the quality of digital images taken has increased and the price of the cameras has decreased. Today, many professional photographers use digital cameras to take portraits of people at events and for in-studio sittings. These professional photographers desire to print the digital images taken on traditional photographic paper to make the photographs more like traditional pictures taken with conventional cameras. Furthermore, the use of digital cameras to take digital images as pictures has made the process of placing the image on another product easier. For example, the use of digital images makes it easier to place the image on a coffee mug, t-shirt, or calendar. For purposes of this discussion, these items will be termed “photographic products”. A photographic product is any product that is produced with the digital image taken from a camera.

### SUMMARY

A photographer computing device is described. The device receives information that specifies option(s) to create a photographic product from a digital image; a list of fulfillment center(s) to generate the product according to the options, and routing information to at least one of the center(s). The device transmits an order for the product to at least one center. The order specifies a method (e.g., at will or within a specified or negotiated period of time) for the device to communicate the image to selected ones of the center(s). The delivery method is independent of receipt of any type of request or prompt for the image from any other computing device including the gateway device and any fulfillment center. The device uploads the image as per the delivery technique, and receives confirmation that the order has been received.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The above and other features and aspects of the systems, apparatus, and methods are described in the Detailed Description given below and shown in the following drawings:

FIG. 1 illustrating a block diagram of computer systems connected to the Internet to provide service in accordance with the described systems, apparatus, and methods;

FIG. 2 illustrating a block diagram of a processing system of a computer system that provides service in accordance with the described systems, apparatus, and methods;

FIG. 3 illustrating a flow diagram of a process executed by a gateway processor in accordance with the described systems, apparatus, and methods;

FIG. 4 illustrating a flow diagram of a process executed by a photographer computing device in accordance with the described systems, apparatus, and methods;

FIG. 5 illustrating a flow diagram of a process executed by a fulfillment center processing unit in accordance with the described systems, apparatus, and methods;

FIG. 6 illustrating a flow diagram of a process for updating accounts executed by the gateway processing unit in accordance with the described systems, apparatus, and methods;

FIG. 7 illustrating a flow diagram of a process for monitoring an order executed by a gateway processing unit in accordance with the described systems, apparatus, and methods; and

FIG. 8 illustrating a flow diagram of a process for processing an order executed by the fulfillment center processing unit in accordance with the described systems, apparatus, and methods.

### DETAILED DESCRIPTION

### Overview

A system that can find a producer of a desired product and that allows a photographer to quickly place an order for these products would be very useful. This type of system could be used by professional and novice photographers alike to find producers and quickly place and control orders for photographic products. The above and other problems are solved and an advance in the art is made by the digital image transfer system of the following described systems, apparatus, and methods. The described systems, apparatus, and methods use a distributed system to allow a user, such as a photographer, to find a producer of a photographic product, place an order, and substantially control upload of a digital image associated with the order to the producer. The described systems, apparatus, and methods allow a gateway server to provide a photographer with a list of fulfillment centers that can complete the order. The gateway server acts as a middle man by taking a photographer's needs and finding fulfillment centers that can meet the needs of the photographer. In one implementation, the gateway server can then deliver the order to a fulfillment center and transmit the end user's preferred delivery technique/method to deliver the digital image from the photographer to the fulfillment center. For purposes of this discussion, a fulfillment center is an entity that produces a product from a given digital image. For example, a fulfillment center may be a photographic laboratory that prints photographs on photographic paper, or a graphics company that places a digital image on a coffee mug, calendar, t-shirt, or some other product.

In accordance with the described systems, apparatus, and methods, processing unit(s) are used to establish a transfer of a digital image to a fulfillment center to generate a photographic product. A photographer has a computer system which is referred to, for example, as a photographer processing unit/device that connects to the Internet. The photographer processing unit is a server or a personal computer system that connects to the Internet via a server. A gateway processing unit is a server that connects to the Internet to communicate with a photographer processing unit to receive an order and provide the photographer processing device with routing information to a fulfillment center that generates the photographic product. In one implementation, the gateway processing unit communicates with a fulfillment center processing unit to place orders and monitor the status of the order.

In another implementation, orders are placed directly by the photographer processing unit. The fulfillment center generating the photographic product has a server or computer system that connects to a server for Internet connection and is referred to as a fulfillment center processing unit.

In one implementation, a gateway processing unit executes software instructions to provide the following steps for transferring a digital image to a fulfillment center to generate a photographic product. The gateway processing unit maintains a list of fulfillment centers available to generate a photographic product from the digital image. The photographic processing unit transmits a request for a list of options for photographic products that can be generated from a digital image. The gateway processing unit receives the request from a photographer for the list of options to generate the photographic products. The gateway processing unit then transmits a display of the list of options to the photographer processing unit.

The photographer processing unit displays the list of options to the photographer. The photographer then inputs an order for photographic products from a digital image. The photographer processing unit then transmits the order to the gateway processing unit.

The gateway processing unit receives the order from the photographer processing unit. The order may contain parameters for selecting a fulfillment center to process the order. The parameters may include the type of products to be generated, location of the fulfillment center, a particular fulfillment center, time frame, and/or other parameters for processing the order—including digital image upload method specifics and the price for the photographic products.

The gateway processing unit then determines which fulfillment center will process the order. In one implementation, the gateway processing unit then transmits routing information to the photographer processing unit. This routing information is not a request for the photographer processing unit to download or upload the image to a fulfillment center. Rather, the routing information is information for the photographer processing unit to transmit the digital image at will or according to a user specified set of criteria (e.g., within a negotiated time frame, etc.) to the fulfillment center selected to process the order. In one implementation, the gateway processing unit then transmits the order to the selected fulfillment center. In another implementation, the order is transmitted to the fulfillment center by the photographer processing unit.

Independent of any request or prompt for the digital image, and in one implementation, the gateway processing unit may receive the digital image from the photographer processing unit for transmission to the fulfillment center processing unit of the fulfillment center processing the order. The gateway processing unit may receive the digital image when the fulfillment processing unit is not connected to the Internet or is not available to receive the digital image. In this scenario, the digital image may be stored in a memory, and the gateway processing unit then transmits to the fulfillment center processing unit at a later time when the fulfillment processing unit is connected to the Internet and ready to receive the digital image. Alternatively, the photographer processing unit waits until it has verified that the fulfillment center is online before transmitting the digital image to the center, wherein the transmission is independent of any request or prompt from any other computer, including the gateway server and the fulfillment center.

After the digital image is transmitted by the photographer processing unit, in one implementation, the photographer processing unit transmits a confirmation to the gateway processing unit. The confirmation indicates that the digital image has been transmitted to the fulfillment center processing unit. The gateway processing unit receives the confirmation from the photographer and may use the confirmation to monitor the status of the order. When an order is completed by a fulfillment center, the fulfillment center processing unit transmits a confirmation to the gateway processing unit that the order has been completed. The confirmation is received by the gateway processing unit which updates a record of the order to indicate that the order has been fulfilled. Alternatively, and as instructed by the photographer processing unit, the fulfillment center may send the confirmation directly to the photographer processing unit.

In one implementation, the gateway processing unit also monitors the order to receive payment from the photographer and distribute the payment to the fulfillment center. When an order is received, the gateway processing unit debits an account of the photographer placing the order. The gateway processor then receives a transfer of funds from the said photographer. When the photographer transmits funds, the gateway processing unit credit the funds to the photographer's account. In some embodiments, the transfer of funds may be an electronic transfer where the photographer submits a credit card account number or a bank account number. In these embodiments, the gateway processing unit may wait to transmit the order to the fulfillment center processing unit until the funds are received. After the funds are received from the photographer, the gateway processing unit credits the funds received from the photographer to an account of the fulfillment center processing the order. The gateway processor may also periodically debit a service charge to the account of the fulfillment center for use of this service.

In one embodiment, the gateway processor maintains a count of the number of orders that the fulfillment center receives. After the fulfillment center receives a specified number of orders, the gateway processing unit may debit a transactional charge for each additional order received by a fulfillment center. The gateway processing unit may also maintain a web page listing the fulfillment centers available to process orders to allow a photographer to view the fulfillment centers available to process orders. The web page may contain hyper-link text pointing to web pages of each fulfillment center listing the prices, products, and services available from a particular fulfillment center.

In one implementation, the photographer processing unit executes software which executes, for example, the following operations to provide the services in accordance with the described systems, apparatus, and methods. The photographer processing unit begins by establishing a connection with the gateway processing unit. The photographer processing unit then receives an input from a photographer requesting a list of options available. The request may include parameters such as fulfillment center name, fulfillment center locations, photographic products desired, prices, and services provided. The request then is transmitted to the gateway processing unit which responds by transmitting a display showing the options available. The photographer processing unit receives the display of the list of options available and displays the list to the photographer. The photographer processing unit then receives an input of the order and transmits the order to the gateway processing unit. The order may contain a graphics instruction set for graphics to be added to the digital image. This graphics instruction set may also be transmitted with the digital image to the fulfillment center processing unit at a later time.

In response to transmitting the order, the photographer processing unit receives the routing information for the digital image from the gateway processing unit. The photographer processing unit independently transmits (independent of any prompts or requests for the image) the digital image using the routing information. The routing information includes instructions to transmit the digital image directly to a fulfillment center processing unit, transmit the digital image to the gateway processor, or store the digital image to a media for delivery of the digital image via mail or other courier service. In this exemplary implementation, and after the digital image is transmitted, the photographer processing unit transmits a confirmation to the gateway processing unit that the digital image was transmitted. The photographer processing unit may also transmit account information to the gateway processing unit for payment of the order.

In accordance with the described systems, apparatus, and methods, each fulfillment center has a fulfillment center processing unit which connects to the Internet and executes the following instructions to receive a digital image and generate a photographic product. The fulfillment center processing unit receives an order for photographic products from the gateway processing unit and receives the digital image from either the gateway processing unit or the photographer processing unit. The order then is processed to generate the photographic product from the digital image.

The fulfillment center processing unit may store the digital image in a memory to process the order at a later time. In one implementation, when the fulfillment center processing unit stores the digital image, the digital image is deleted from memory. In one embodiment, the digital image is deleted either after a specified period of time or after the order is processed.

In one implementation, to allow the gateway processing unit to monitor the status of an order, the fulfillment center processing unit transmits a status of the order periodically to the gateway processing unit. The transmitted status updates may include a confirmation when an order is received and a confirmation when a digital image is received. The fulfillment center processing unit may also transmit a status report indicating the availability of the fulfillment center to fulfill subsequent orders.

In one implementation, and to generate a photographic product, the fulfillment center processing unit must first generate a proof of a desired photographic image from the digital image and a graphics instruction set which includes instructions for adding graphics to the digital image. The graphics instruction set may either be received in the order or may be received from the photographer processing unit with the digital image.

### An Exemplary System

The described systems, apparatus, and methods relate to an Internet-based service for providing photographers with a means for finding fulfillment centers that provide desired photographic products, for placing orders with the fulfillment centers, and for transferring a digital image from the photographer to the fulfillment center. For purposes of this discussion, a photographic product is a photograph on photographic paper, or any other product on which a digital image is imprinted. Some examples of such products include, but are not limited to, calendars, t-shirts, coffee mugs, and trading cards. Also for purposes of this discussion, a fulfillment center is a photographic laboratory or other printing shop which places a digital image onto a product. It is envisioned that the described systems, apparatus, and methods will provide photographers in professional photographic studios with a fast and convenient way to find fulfillment centers to fulfill orders for products from digital images that the photographer has taken.

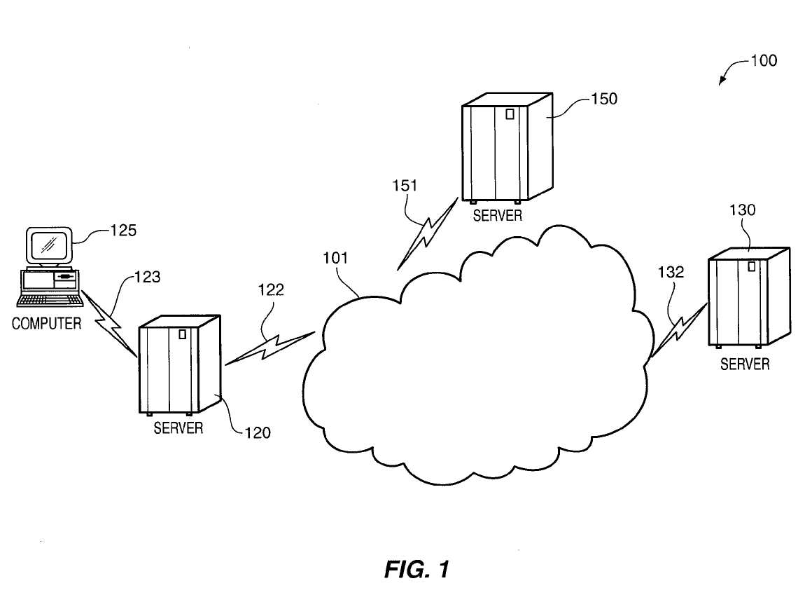

FIG. 1 illustrates the computer systems used to provide the described systems, apparatus, and methods in one embodiment. A photographer has a computer system 125 that connects to an Internet server 120 via communication path 123. One skilled in the art will recognize that communication path 123 may be a telephone line, a coaxial cable connection, LAN, WAN, a T1 communication line, DSL connection, or any other means of communication connection that allows computer systems to exchange data. Internet server 120 connects to Internet 101 via communications path 122. One skilled in the art will recognize that communications path 122 is any form of connection between computer systems that provides for communication between computer systems; and the exact type of connection is unimportant with regards to the described systems, apparatus, and methods. One skilled in the art will also recognize that computer 125 and server 120, in fact, may be the same computer system; and the exact configuration is not important to the described systems, apparatus, and methods. For purposes of this discussion, the systems connecting a photographer to the Internet are termed a photographer processing unit which is a system that can execute instructions in hardware, software, or firmware to perform the processes of the described systems, apparatus, and methods.

A gateway server 150 connects to Internet 101 via communications path 151. One skilled in the art will recognize that any type of connection that facilitates communications with other computer systems connected to Internet 100 may be used. Gateway server 150 performs the routing and management functions of the described systems, apparatus, and methods to transfer orders from a photographer to a fulfillment center. For purposes of this discussion, gateway server is termed a gateway processing unit which is a processing system that can execute instructions stored in hardware, software, or firmware in order to provide processes in accordance with the described systems, apparatus, and methods. One skilled in the art will recognize that gateway server 150 may be connected to other computer systems and processing units that provide the processes of the described systems, apparatus, and methods.

Each fulfillment center that uses this service has a fulfillment center server 130 that connects to Internet 101 via communications path 132. For purposes of this discussion, fulfillment center server 130 is called a fulfillment center processing unit because, although shown as a single computer system in FIG. 1, fulfillment center server 130 also may have one or more connected computer systems that perform the processes in accordance with the described systems, apparatus, and methods.

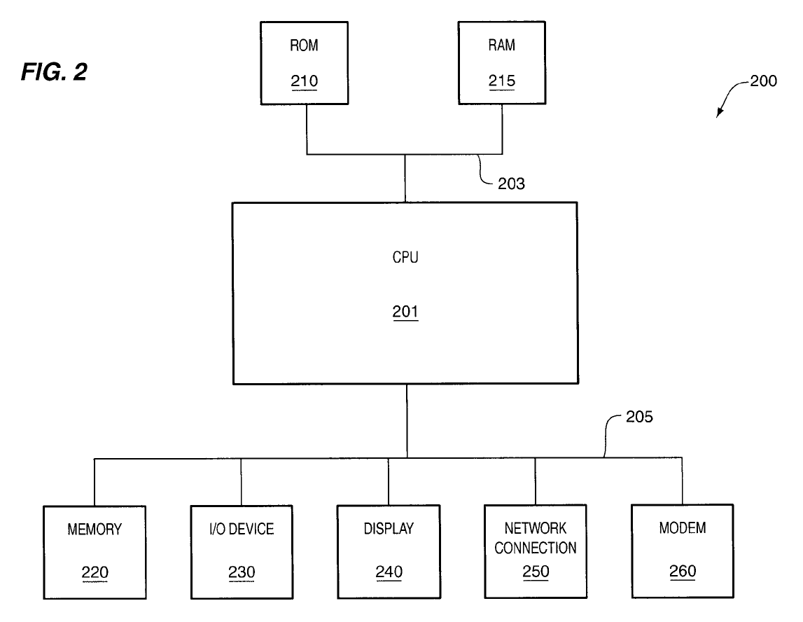

FIG. 2 illustrates a typical processing unit 200 that performs the functions of the gateway processing unit, the fulfillment processor unit, or the photographer processing unit. Central Processing Unit (CPU) 201 is a processor, microprocessor, or group of processors and/or microprocessors that execute instructions stored in a memory to perform applications. Memory bus 203 connects CPU 201 to a non-volatile memory, such as Read Only Memory (ROM) 210 and a volatile memory, such as Random Access Memory (RAM) 215. ROM 210 stores instructions such as BIOS and configuration information for processing unit 200. RAM 215 stores instructions and data needed to perform an application being executed by CPU 201.

Input/Output (I/O) bus 205 connects CPU 201 to I/O devices to receive and transmit data. A secondary memory device 220 may be connected to I/O bus 205. Secondary memory device 220 is a device that stores data or instructions to a media for later use by CPU 201. I/O device 230 may also connect to I/O bus 205. I/O device 230 is a device such as a keyboard, joystick, or a mouse that allows a user to input data. Display 240 may be connected to I/O bus 205. Display 240 includes device drivers and monitors needed to display data to a user. Network connection 250 may also be connected to I/O bus 205 to connect processing unit 200 to a network such as a LAN or a WAN. A common network connection 250 is an Ethernet card for a personal computer. Modem 260 may also be connected to I/O bus 205 to provide a connection over a telephone line to another computer system. One skilled in the art will recognize that the devices shown in FIG. 2 are exemplary, and many other types of devices may be connected to I/O bus 205.

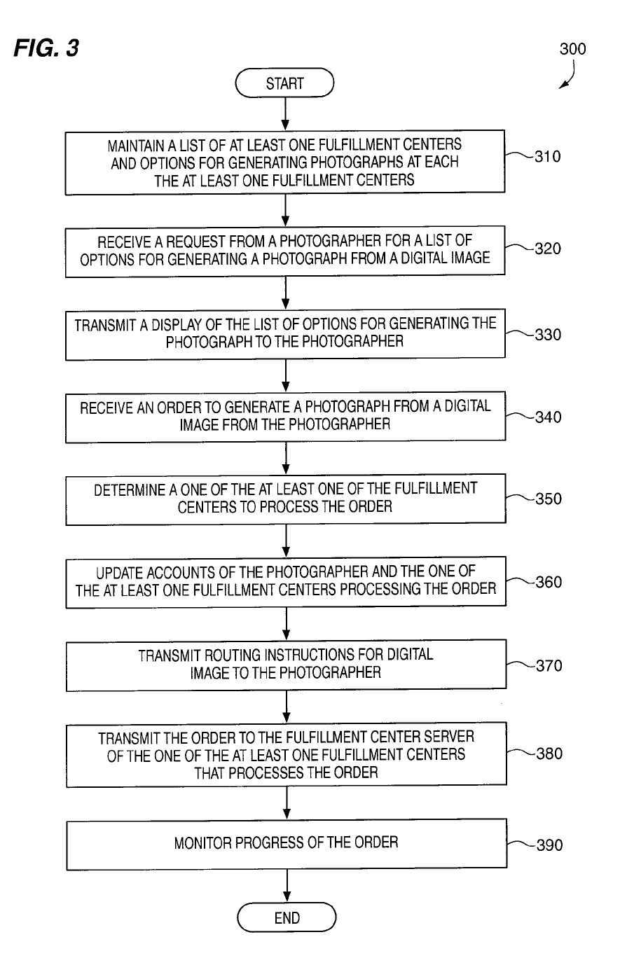

The described systems, apparatus, and methods allow a photographer to find a fulfillment center to process an order for a photographic product. In one embodiment, there are three processing units in the system. FIGS. 3-8 are flow charts illustrating the processes performed by the different processing units in accordance with the described systems, apparatus, and methods.

FIG. 3 illustrates process 300 executed by a gateway processing unit to find a fulfillment center for a photographer to process an order for photographic products. Process 300 begins in step 301 by maintaining a list of at least one fulfillment centers and options provided by each of the at least one fulfillment centers for generating photographic products. In step 320, the gateway processing unit receives a request from a photographer processing unit. The request is for a list of options for photographic products to generate from a digital image. The request may include parameters from a photographer to select a fulfillment center. The parameters may include photographic products offered, location, time to produce orders, and prices.

In step 330, the gateway processing unit transmits a display of the list of options for generating a photographic product and a list of at least one fulfillment center that can fulfill the order. In step 340, the gateway processing unit receives an order from a photographic processing unit to generate a photographic product from a digital image. The order may include a graphics instruction set that is instructions for adding graphics to the digital image when the photographic product is generated.

When the order is received, the gateway processing unit determines a fulfillment center to process the order in step 350. The parameters in the request or in the order may be used to determine the fulfillment center to process the order. It should be noted that the order may specify the fulfillment center to process the order. Once the fulfillment center is determined, the gateway processing unit updates accounts of the photographer and the fulfillment center to reflect the order being placed and funds being received in step 360.

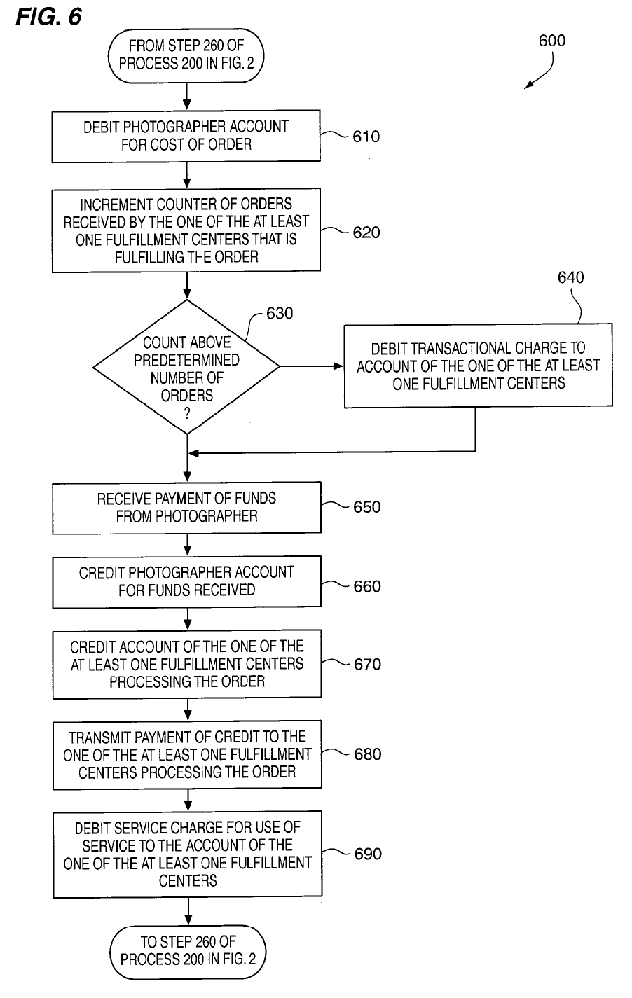

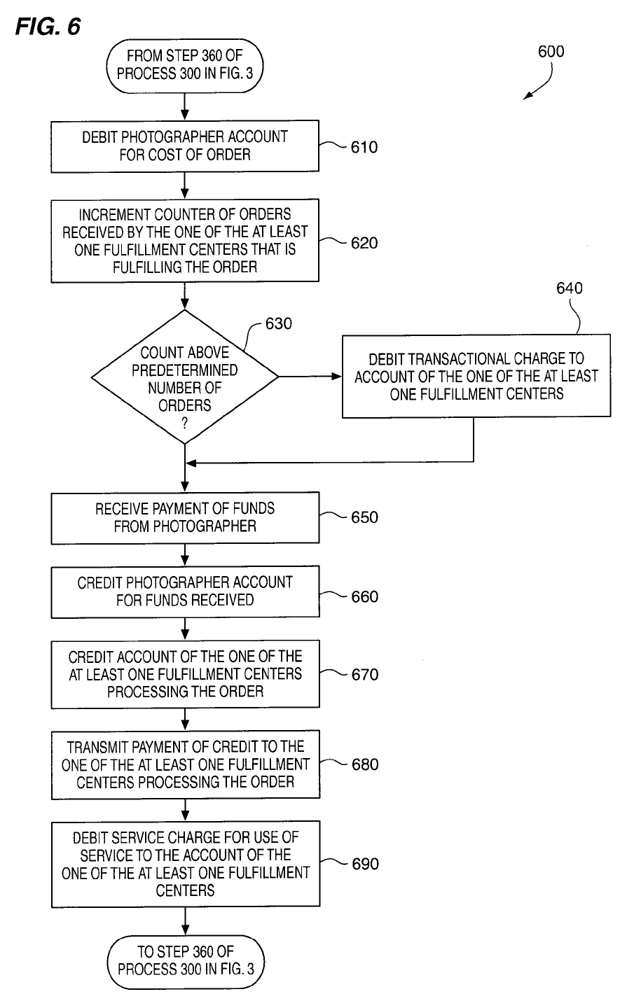

Process 600 illustrated in FIG. 6 is a process for updating accounts in step 360 in process 300. Process 600 begins in step 610 with the gateway processing unit debiting an account of the photographer for the price of the order. In step 620, the gateway processing unit increments the count of orders to the fulfillment center. This is important when the fulfillment center pays a flat fee for a predetermined number of orders and a subsequent transactional charge for each order above the predetermined number.

In step 630, the gateway processing unit determines whether the order count is greater than the predetermined number of orders. If the count is above the predetermined number of orders, the gateway processing unit debits a service charge to the fulfillment center for the order in step 640. If the count is not above the predetermined number or after the service charge is debited, the gateway processing unit receives a payment of funds from the photographer for the order in step 650. Payment may be by electronically debiting a charge account, electronically debiting a bank account, an electronic transfer of funds, or receiving a check or money in a physical transfer of funds.

Once the funds are received, the gateway processing unit credits the funds to the account of the photographer in step 660. The gateway processing unit then credits funds for the order to the fulfillment center account in step 670. In step 680, the credited funds are transmitted to the fulfillment center. The transmission may be an electronic transfer of funds or periodically sending a check or other funds to the fulfillment center. In step 690, the gateway processing unit debits a service charge for using the service to the account of the fulfillment center. The service charge may be a periodic charge. For example, a fulfillment center may pay a service charge every year, month, or quarter year for a certain number of transactions in that time period.

Referring back to FIG. 3, process 300 continues in step 370 with the gateway processing unit transmitting routing instructions to the photographer processing unit. The routing instructions are instructions for transmitting the digital image from the photographer processing unit to the fulfillment center. These routing instructions may include instructions for transmitting the digital image to the gateway processing unit which in turn will transmit the digital image to the fulfillment center, instructions for transmitting the digital image to the fulfillment center by placing the image on a media and mailing the media to the fulfillment center, or transmitting the digital image to a fulfillment center processing unit via the Internet.

In step 380, the gateway processing unit then transmits the order to the fulfillment center processing unit chosen to process the order. In step 390, the gateway processing unit then monitors the progress of the order until the order is completed. Process 300 then ends. In one implementation, the gateway processing unit does not transmit the order to the fulfillment center(s), but rather, the photographer processing unit transfers the order to one or more fulfillment centers.

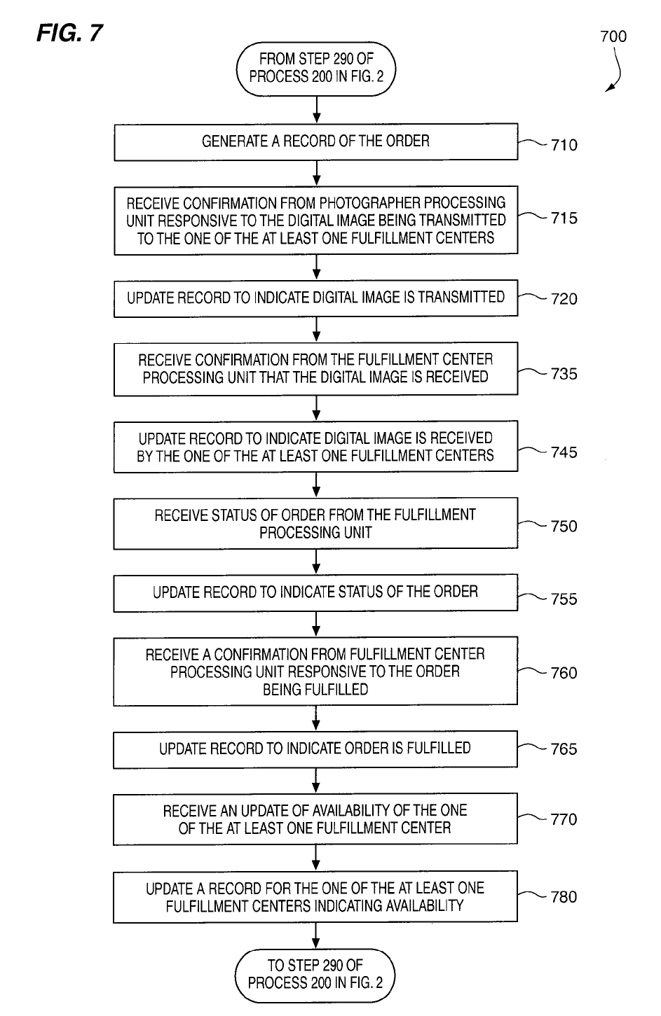

FIG. 7 illustrates a flow chart of an embodiment of a process 700 performed by the gateway processing unit in step 380 of process 300. Process 700 begins in step 710 with the gateway processor generating a record for the order. The record may be a record in a database that stores a record of the orders. In step 715, the gateway processing unit receives a confirmation from the photographer processing unit that the digital image has been transmitted. The record is updated by the gateway processing unit in step 720 to reflect that the confirmation was received.

In step 735, the gateway processing unit receives confirmation from the fulfillment center processing unit that the digital image was received. In step 745, the gateway processing unit updates the record to reflect the confirmation of receipt of the digital image was received from the fulfillment center processing unit. In step 750, the gateway processing unit receives a status of an order from the fulfillment center processing unit. The status of the order may be received periodically so that the gateway processing unit may continually track the status of the order. In step 755, the gateway processing unit updates the record to indicate the status of the order.

In step 760, the gateway processing unit receives a confirmation from the fulfillment center processing unit when the order has been fulfilled. In step 760, the gateway processing unit updates the record to indicate the order is fulfilled. At this time, the gateway processing unit may transmit an e-mail or other notification to the photographer processing unit indicating the order has been fulfilled.

In step 770, the gateway processing unit receives an update from the fulfillment center processor indicating the availability of the fulfillment center to process subsequent orders. The gateway processing unit then updates a record for the fulfillment center indicating the availability of the fulfillment center in step 780.

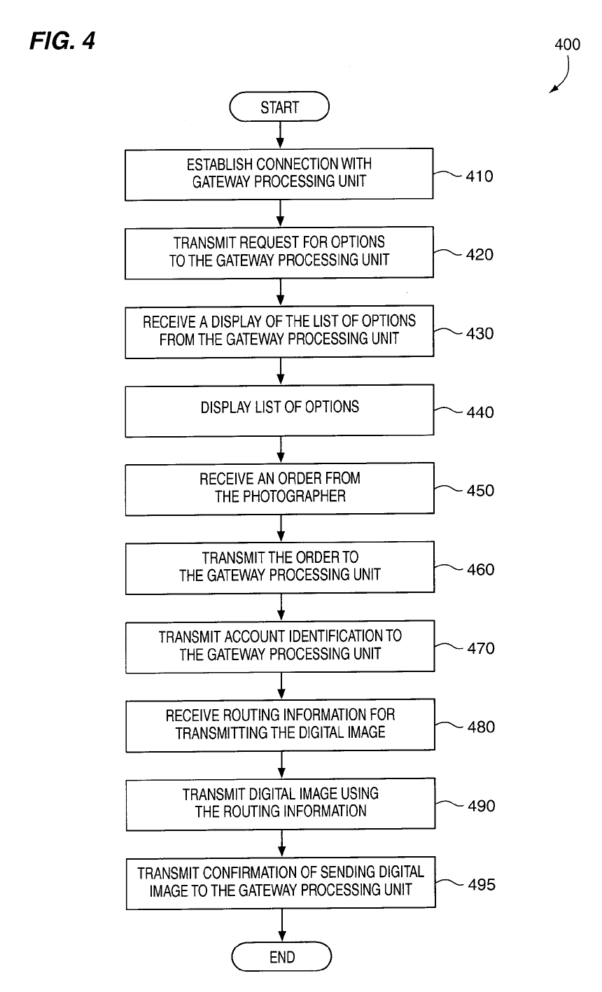

FIG. 4 illustrates a flow chart of process 400 executed by a photographer processing unit in accordance with the described systems, apparatus, and methods. Process 400 begins in step 410 in which the photographer processing unit establishes a connection with the gateway processing unit. The connection may be made by a direct connection, such as a dial-up telephone connection or an Internet connection using software such as a web browser.

In step 420, the photographer processing unit transmits a request to the gateway processing unit for the list of options of photographic products that may be produced from the digital image. In response to the request, the photographer processing unit receives a display of a list of options for photographic products from the gateway processing unit in step 430. The display then is displayed to a photographer in step 440.

In step 450, the photographer processing unit receives an input of an order for photographic products from a photographer. The order then is transmitted to the gateway processing unit in step 460. In step 470, account information for paying for the order is transmitted to the gateway processing unit. The account information may be an account with a gateway provider, a credit card account, or a bank account from which to withdraw.

In step 480, the photographer processing unit receives routing information from the gateway processing unit. The routing information is instructions for transmitting the digital image from the photographer processing unit to the fulfillment center. As stated above, the routing information may tell the photographer processing unit to transmit the digital image to the gateway processing unit, transmit the digital image directly to the fulfillment center processing unit, or store the digital image to a media and send the media to the fulfillment center.

In step 490, the photographer processing unit transmits the digital image using the routing information. After the digital image is transmitted, the gateway processing unit transmits a confirmation to the gateway processing unit that the digital image was transmitted and process 400 ends.

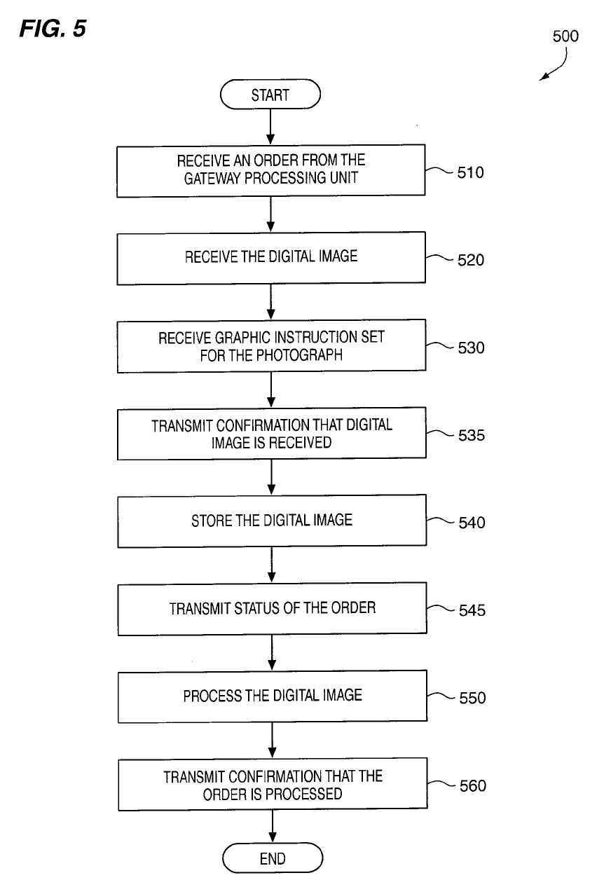

FIG. 5 illustrates a process 500 executed by the fulfillment center processing unit in accordance with the described systems, apparatus, and methods. Process 500 begins in step 510 with the fulfillment center processing unit receiving an order from the gateway processing unit. In step 520, the fulfillment center processing unit receives the digital image. As stated above, the digital image may be received from the gateway processing unit or directly from the photographer processing unit.

In step 530, the fulfillment center processing unit receives a graphics instruction set. As stated above, the graphics instruction set may be received as part of the order, as part of the digital image transmitted, or as a separate transmission from either the gateway processing unit or the photographer processing unit. In step 535, the fulfillment center processing unit transmits a confirmation to the gateway processing unit that the digital image was received. In step 540, the digital image and graphics instruction set are stored in a memory for later use in processing the order. In step 545, the fulfillment center processing unit periodically transmits a status of the order.

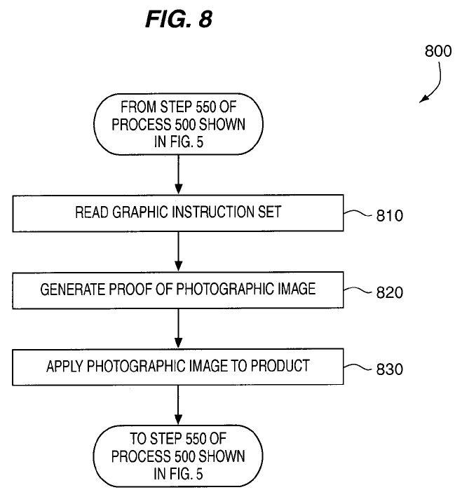

In step 550, the fulfillment center processing unit processes the digital image to generate the photographic product and fulfill the order. FIG. 8 illustrates a process 800 executed by the fulfillment center processor in step 550 to process an order. Process 800 begins in step 810 by reading the graphics instruction set. In step 820, the fulfillment center processing unit generates a proof of the digital image with the graphics added. This allows a user at the fulfillment center to correct any defects in the image with added graphics to generate a better picture. When the user is satisfied with the image with added graphics, the image is applied to the desired photographic product to complete the order and process 800 ends. Referring back to FIG. 5, process 500 then ends by the fulfillment center processing unit transmitting confirmation that the order has been processed.

### CONCLUSION

Although the above systems, apparatus, and methods are described in language specific to structural features and/or methodological operations or actions, the implementations defined in the appended claims are not necessarily limited to the specific features or actions described. Rather, the specific features and operations for the described systems, apparatus, and methods are disclosed as exemplary forms of implementing the claimed subject matter.

1. A photographer computing device comprising:
a processor; and
a memory coupled to the processor, the memory comprising computer executable instructions that, when executed by the processor, direct the photographer computing device to perform acts comprising:
receiving information from a gateway server, the information including: (a) option(s) to create a photographic product from a digital image; (b) a list of one or more fulfillment centers to generate, according to one or more of the options, the photographic product; and (c) routing information to transmit the digital image to at least one of the fulfillment center(s);
transmitting an order for the photographic product to the one or more centers of the fulfillment center(s) to process the order, the order specifying the one or more centers, the order specifying a delivery technique to communicate the digital image to respective ones of the center(s), the delivery technique comprising an indication that delivery of the digital image to at least a subset of the one or more centers will be independent of receipt, by the photographer computing device, of a request for the digital image from any other computing device including the gateway device and any of the at least a subset, the request comprising one or more of a message and information associated with a graphical element for display inviting a user of the photographer computing device to upload the digital image;
uploading to digital image to respective ones of the subset according to the delivery technique; and
responsive to the uploading, receiving a confirmation that the order has been received by a center of the subset for the photographic product.

2. The photographer computing device of claim 1 wherein the delivery technique further comprises an indication that the digital image will be uploaded to at least one of the subset at will of the photographer computing device.

3. The photographer computing device of claim 1 wherein transmitting further comprises sending the order to the gateway server for forwarding by the gateway server to at least one of the one or more centers.

4. The photographer computing device of claim 1 wherein the delivery technique further comprises an indication that the digital image will be uploaded to at least one of the subset within a select period of time from placement of the order with the gateway device or the at least one of the subset.

5. The photographer computing device of claim 4 wherein the select period of time is negotiated between the at least one center and the photographer computing device, specified solely by the photographer computing device, or specified solely by respective ones of the at least one center.

6. The photographer computing device of claim 1 wherein the acts further comprise communicating a confirmation to the gateway server, the confirmation indicating that the digital image was transmitted to one or more select fulfillment center(s).

7. A tangible computer-readable storage medium comprising:
computer executable instructions that, when executed by a processor on a computing device, cause the computing device to perform operations comprising:
receiving information from a gateway server, the information including: (a) option(s) to create a photographic product from a digital image; (b) a list of one or more fulfillment centers to generate, according to one or more of the options, the photographic product; and (c) routing information to transmit the digital image to at least one of the fulfillment center(s);
transmitting an order for the photographic product to the one or more centers of the fulfillment center(s) to process the order, the order specifying the one or more centers, the order specifying a delivery technique to communicate the digital image to respective ones of the center(s), the delivery technique comprising an indication that delivery of the digital image to at least a subset of the one or more centers will be independent of receipt by the processor of a request or prompt for the digital image from any other computing device including the gateway device and any of the at least a subset;
uploading the digital image to respective ones of the subset according to the delivery technique; and
responsive to the uploading, receiving a confirmation that the order has been received by a center of the subset for the photographic product.

8. The tangible computer-readable storage medium of claim 7 wherein the delivery technique further comprises an indication that the digital image will be uploaded to at least one of the subset at will of the processor as directed by the computer-executable instructions.

9. The tangible computer-readable storage medium of claim 7 wherein the delivery technique further comprises an indication that the digital image will be uploaded to at least one of the subset within a select period of time from placement of the order with the gateway device or the at least one of a subset.

10. The tangible computer-readable storage medium of claim 9 wherein the select period of time is negotiated between the at least one center and the photographer computing device, specified by the photographer computing device, or specified by the at least one center.

11. The tangible computer-readable storage medium of claim 7 wherein the acts further comprise communicating a confirmation to the gateway server, the confirmation indicating that the digital image was transmitted to one or more select fulfillment center(s).

12. A gateway server comprising:
a processor; and
a memory coupled to the processor, the memory comprising computer executable instructions that, when executed by the processor, direct the photographer computing device to perform acts comprising:
receiving a request from a photographer computing device for information, the information including: (a) option(s) to create a photographic product from a digital image; (b) a list of one or more fulfillment centers to generate, according to one or more of the options, the photographic product;
and (c) routing information to transmit the digital image to at least one of the fulfillment center(s);
responsive to receiving the request, communicating the information to the photographer computing device;
receiving an order for the photographic product from the photographer computing device, the order specifying at least one center of the one or more centers and a delivery technique to communicate the digital image to respective ones of the at least one center, the delivery technique comprising an indication that delivery of the digital image to at least a subset of the one or more centers will be independent of receipt by the photographer computing device of a request for the digital image from any other computing device including the gateway device and any of the at least one center, the request comprising one or more of a message and information associated with a graphical element for display inviting a user of the photographer computing device to upload the digital image;
responsive to the order being communicated to the at least one center, monitoring a status of the order at the at least one center; and
communicating the status to the photographer computing device or a corresponding one of the at least one center.

13. The gateway server of claim 12 wherein the delivery technique further comprises an indication that the digital image will be uploaded to the at least one center at will of the photographer computing device.

14. The gateway server of claim 12 wherein the delivery technique further comprises an indication that the digital image will be uploaded by the photographer computing device to the at least one center within a select period of time from placement of the order with the gateway device or the at least one center.

15. The gateway server of claim 14 wherein the select period of time is negotiated between the at least one center and the photographer computing device, specified solely by the photographer computing device, or specified solely by respective ones of the at least one center.

16. The gateway server of claim 12 wherein the acts further comprise communicating a confirmation to the photographer computing device, the confirmation indicating that the order was accepted by the at least one center.
